(19) United States
(12) Patent Application Publication
(10) Pub. No.: US 2011/0261679 A1
(43) Pub. Date: Oct. 27, 2011

(54) METHOD FOR TRANSMITTING HARQ-ACK

(76) Inventors: Yingyang Li, Gyeonggi-do (KR); Xiaoqiang Li, Gyeonggi-do (KR)

(21) Appl. No.: 13/141,914

(22) PCT Filed: Dec. 30, 2009
(86) PCT No.: PCT/KR2009/007998

§ 371 Date: Jun. 23, 2011

(30) Foreign Application Priority Data
Dec. 30, 2008 (CN) 200810187455.3

(51) Int. Cl. H04L 12/26

(52) U.S. Cl. 370/216

(57) ABSTRACT

A method for transmitting HARQ-ACK, for N downlink component carriers and 1 uplink component carrier, transmitting HARQ-ACK information of N downlink component carriers in HARQ-ACK channel of an uplink component carrier, one of N downlink component carrier being a reference downlink component carrier, comprising steps of: on consecutive HARQ-ACK channels beginning with the first of N downlink component carrier, transmitting HARQ-ACK for CCE in the reference downlink component carrier; and on consecutive HARQ-ACK channels beginning with N(I)PUCCH, N(I)PUCCH+f(k) transmitting HARQ-ACK for CCE in other downlink component carriers, wherein k is information related to downlink component carrier. The method of this invention can reduce the HARQ-ACK channel overhead of uplink component carrier and the limitations on the flexibility of the scheduler in the base station.

### TECHNICAL FIELD

This invention relates to a wireless communication system, and especially to a method for reducing HARQ-ACK overhead in the wireless communication system when carrying out data transmission based on a hybrid automatic repeat request (HARQ).

### BACKGROUND ART

In the wireless communication system, downlink transmission indicates sending signals from a base station to user equipment. Downlink signals include data signals, control signals and reference signals (pilot frequency). Downlink data signals are transmitted in a physical downlink shared channel (PDSCH). Uplink transmission indicates sending signals from the user equipment to the base station. Uplink signals also include data signals, control signals and reference signals (pilot frequency). Uplink data signals are transmitted in a physical uplink shared channel (PUSCH). When there is no uplink data signals, uplink control signals are transmitted in a physical uplink control channel (PUCCH). For example, in a 3GPP LTE system, downlink transmission is implemented by Orthogonal Frequency Division Multiple Access (OFDMA), while uplink transmission is implemented by Single Carrier Frequency Division Multiple Access (SCFDMA).

Downlink control signals can be broadcasted or specific to user equipment. Broad-casting control signals are sent to all user equipments, such as broadcast channel (BCH) and physical control format indicator channel (PCFICH). Control signals specific to user equipment are sent to a certain user equipment, for providing downlink scheduling distribution signaling for scheduling PDSCH transmission and uplink scheduling dis-tribution signaling for scheduling PUSCH transmission, referred to as physical downlink control channel (PDCCH). Or providing ACK/NACK information for HARQ transmission of PUSCH, referred to as physical HARQ indicator channel (PHICH). Uplink control signals include ACK/ACK signal for HARQ transmission of PDSCH (HARQ-ACK), channel quality indicator (CQI) signal and scheduling request indicator (SRI) signal.

In the LTE, physical time frequency resource is divided into a plurality of physical resource blocks (PRB), each of blocks contains 12 consecutive sub-carriers in a frequency domain and N consecutive symbols in a time domain, being OFDM symbol for the downlink, and SCFDMA symbol for the uplink. N refers to the number of symbols within a time slot.

As shown in FIG. 3, time frequency resources occupied by PUCCH are positioned at both ends of frequency band for the system. Meanwhile, in order to obtain frequency diversity effect, in a subframe, uplink control channel occupies a RB (301) at an upper end of frequency band in a first time slot and a RB (302) at a lower end of frequency band in a second time slot, or a RB (303) at the lower end of frequency band in the first time slot and a RB (304) at the upper end of frequency band in the second time slot. Based on the conventional solution, for frame structure with general CP, the number of reusable HARQ-ACK channels in each RB can be 36, 18 or 12; for frame structure with extended CP, the number of reusable HARQ-ACK channels in each RB can be 24, 12 or 8.

When transmitting data based on HARQ, data receiver transmits ACK or NACK feedback information correspondingly on the basis of whether the data is received correctly. Here, the scheduling of data transmission is completed through PDCCH, and ACK/NACK feedback signal for HARQ transmission of PDSCH is transmitted in PUCCH HARQ-ACK channels. ACK/NACK feedback signal for HARQ transmission of PUSCH is transmitted in PHICH channels.

In the LTE, the number of OFDM symbols in each downlink subframe for transmitting downlink control signals is configured through dynamically PCFICH. In general, the number is 1, 2 or 3. PDCCH implements an independent coding and transmission for each user equipment and independent transmission for uplink and downlink scheduling in the same user equipment. Physical time frequency resources occupied by PDCCH are composed of one or more control channel elements (CCE), each of which contains 36 time frequency resource elements (RE), and PDCCH is composed of 1, 2, 4, or 8 CCEs. In order to facilitate HARQ transmission of downlink data, it is required to confirm PUCCH HARQ-ACK channels used for each scheduled user equipment, hereinafter referred to as HARQ-ACK channel.

In the LTE, for dynamic scheduling, an index of HARQ-ACK channel occupied by user equipment is bound with that of the minimum CCE of PDCCH for scheduling the user equipment impliedly. In the LTE FDD, for PDSCH scheduled in downlink subframe n−4, the index of HARQ-ACK channel occupied by user equipment in uplink subframe n is n_{PUCCH}⁽¹⁾=n_{CCE}+N_{PUCCH}⁽¹⁾, where n_{CCE} is the index of the minimum CCE of PDCCH for scheduling this user equipment, and N_{PUCCH}⁽¹⁾ is a high-level configuration parameter. In the LTE TDD, HARQ-ACK of PDSCH in one or more downlink subframes is transmitted within an uplink subframe.

A block interleaving method is used for mapping. Provided that the number of such downlink subframes is M and a set of the index is called K; for n_{CCE,i} the index of the minimum CCE of the PDCCH in the ith downlink subframe in K set, user equipment first chooses p in (0, 1, 2, 3), which meets Nₚ≦n_{CCE,i}≦Nₚ₊₁ and Nₚ=max{0,└[N_{RB}^{DL}×(N_{sc}^{RB}×p−4)]/36┘}, then the index of HARQ-ACK channel that this CCE is mapped to is n_{PUCCH,i}⁽¹⁾=(M−i−1)×Nₚ+i×Nₚ₊₁+n_{CCE,i}+N_{PUCCH}⁽¹⁾, here is a high-level configuration parameter.

In order to implement higher transmission rate, a larger operating bandwidth can be obtained by combining the plurality of component carriers to constitute the downlink and the uplink of the communication system, that is, Bandwidth Combination. For example, to achieve 100 MHz bandwidth, five 20 MHz component carriers can be combined. In the description herein after, user equipment which can send and receive signals only on one component carrier is called L-UE; and user equipment which can send and receive signals on a number of component carriers is called A-UE. For a number of downlink component carriers in a cell, A-UE can be configured to receive PDSCH only on part of downlink component carriers, and such configured downlink component carrier is called DL CCC. Accordingly, for a number of uplink component carriers in a cell, A-UE can be configured to send PUSCH only on part of uplink component carriers, and such configured uplink component carrier is known as UL CCC.

FIG. 4 is a schematic diagram of downlink bandwidth combination. 100 MHz operating bandwidth (410) is composed of 5 20 MHz downlink component carriers (421˜425). The subframe in each component carrier contains PDCCH area (431˜435) and PDSCH area (441˜445). PDCCH area size in each component carrier can be independently configured via PCFICH dynamically. In this way, overhead of control signals on each component carrier may be controlled as required. For example, for component carriers 0 and 4, PDCCH area is of three OFDM symbols (431) and one OFDM symbol (435). In this way, PDSCH area in component carrier 0 is of 11 OFDM symbols (441), while PDSCH area in component carrier 4 is of 13 OFDM symbols (445). A-UE only needs to test PDCCH on the DL CCC configured in base station. A-UE can simultaneously receive PDSCH on a plurality of component carriers.

In FIG. 4, it is assumed that each component carrier sends independently scheduling distribution signaling, and the transmission of each PDCCH is limited to a component carrier. For example, A-UE (450) receives two independent scheduling signaling 1 (452) and scheduling signaling 2 (453), for scheduling PDSCH on component carriers 1 and 2; A-UE (460) receives scheduling signaling 4 (465) on component carrier 4, for receiving PDSCH on component carrier 4. The method of scheduling PDSCH mentioned also applies to PUSCH scheduling. The principle of uplink bandwidth combination is the same as that of downlink bandwidth combination shown in FIG. 4, each uplink unit bandwidth can be divided into PUCCH area and PUSCH area. In PUCCH area, HARQ-ACK, CQI, and SRI and other control signals can be transmitted. In the LTE, it is allowed that resources in PUCCH area are dynamically scheduled into PUSCH.

FIG. 5 is a schematic diagram of a typical symmetrical bandwidth combination in which the number of uplink and downlink component carriers is the same, so that each downlink component carrier is associated with one uplink component carrier, and each uplink component carrier allocates HARQ-ACK channel for transmitting HARQ of PDSCH in its associated downlink component carrier. For example, L-UE receives PDSCH in downlink component carrier 0, and feeds back HARQ-ACK information in uplink component carrier 0. Each downlink component carrier sends system broadcasting information to transmit configuration parameters mapped by CCE and HARQ-ACK, such as N_{PUCCH}⁽¹⁾.

In other configurations, the number of downlink and uplink component carriers may not be the same. This invention is direct to determine HARQ-ACK channel used in HARQ transmission with asymmetrical bandwidth combination. FIG. 6 is a schematic diagram of asymmetrical bandwidth combination, which can be divided into two cases. Because of operation asymmetry, the number of downlink component carrier configured in a cell may be more than that of uplink component carriers, that is, an uplink component carrier needs to be allocated HARQ-ACK channels for a plurality of downlink component carriers, regardless whether the numbers of uplink and downlink component carriers configured in a cell are the same.

In another case of user-specific asymmetrical bandwidth combination, for example, user equipment receives downlink PDSCH on a plurality of downlink component carriers simultaneously, and sends uplink signal only on uplink component carrier, for reducing the power consumption of user equipment. Methods for determining HARQ-ACK channels in case of user-specific asymmetrical bandwidth combination may be considered. The common ground of both cases above is to allocate HARQ-ACK channels for PDSCH in N (N greater than 1) downlink component carriers in an uplink component carrier; a simple method is to allocate N times HARQ-ACK channels in this uplink component carrier, corresponding to a downlink component carrier respectively. However, this method brings high HARQ-ACK channel overhead, so that a problem is how to reduce HARQ-ACK channel overhead in uplink component carriers. Another method is to allocate only one time HARQ-ACK channel in uplink component carrier, and CCE with the same index in a plurality of downlink component carriers is mapped to HARQ-ACK channels with the same index. However, when CCE is combined into PDCCH, it adopts a “tree” structure in the LTE. That is, for PDCCH with m CCEs, it can only start with CCE with index being multiple of m (m=1,2,4,8). In this way, PDCCH with multiple CCEs on a plurality of component carriers tends to map to the same HARQ-ACK channel, so as to impose bigger restriction on the scheduler.

### DISCLOSURE OF INVENTION

### Technical Problem

An object of this invention is to provide a method for reducing HARQ-ACK overhead in wireless communication systems when supporting data transmission based on hybrid automatic repeat request (HARQ).

### Solution to Problem

To achieve the object, a method for transmitting HARQ-ACK, for N downlink component carriers and 1 uplink component carrier, transmitting HARQ-ACK in-formation of N downlink component carriers in HARQ-ACK channel of an uplink component carrier, one of N downlink component carrier being a reference downlink component carrier, comprising steps of:

on consecutive HARQ-ACK channels beginning with N_{PUCCH}⁽¹⁾, transmitting HARQ-ACK for CCE in the reference downlink component carrier; and

on consecutive HARQ-ACK channels beginning with N_{PUCCH}⁽¹⁾+f(k), transmitting HARQ-ACK for CCE in other downlink component carriers, wherein k is information related to downlink component carrier.

### Advantageous Effects of Invention

With the method of this invention, HARQ-ACK channel overhead of uplink component carrier and limitations on the flexibility of base station scheduler can be reduced.

### BRIEF DESCRIPTION OF DRAWINGS

FIG. 1 is a mapping schematic diagram based on different offsets;

FIG. 2 is a mapping schematic diagram based on different offsets and mode operations;

FIG. 3 is a schematic diagram of PUCCH time frequency resources;

FIG. 4 is a schematic diagram of downlink bandwidth combination;

FIG. 5 is a schematic diagram of symmetrical bandwidth combination;

FIG. 6 is a schematic diagram of asymmetrical bandwidth combination;

FIG. 7 is a schematic diagram of user asymmetrical bandwidth combination;

FIG. 8 is a schematic diagram handling component carriers that only support LTE-A;

FIG. 9 is a schematic diagram of user asymmetrical bandwidth combination with two uplink component carriers;

FIG. 10 is a schematic diagram of user asymmetrical bandwidth combination in asymmetrical bandwidth combination cell.

### MODE FOR THE INVENTION

As shown in FIG. 6, in the communication system with bandwidth combination, in some configurations, the same uplink component carrier needs to be allocated to HARQ-ACK channel of PDSCH in N (N greater than 1) downlink component carriers. This configuration is divided into two kinds. The first one is, in a cell, the number of configured downlink component carriers is more than that of uplink component carriers, where such asymmetry is at cell level, independent of the con-figuration of user equipment within a cell. The second is, for an user equipment, the base station configures user equipment to receive downlink signals only on part of downlink component carriers (DL CCC) and to send uplink signals on part of uplink component carriers (UL CCC). The numbers of DL CCC and UL CCC may be different. Such asymmetry is at user level, independent of whether the total numbers of uplink and downlink component carriers configured in a cell are symmetrical. In other words, it is required to define a method for obtaining HARQ-ACK channel corresponding to CCE in these N downlink component carriers.

Each CCE in a downlink component carrier is mapped to consecutive HARQ-ACK channels beginning with a certain HARQ-ACK index. CCEs in different downlink component carriers are mapped to HARQ-ACK channels consecutively from different HARQ-ARQ index respectively. Here, the principle to configure beginning HARQ-ACK index for each downlink component carrier is to avoid PDCCH with several CCEs in various downlink component carriers being mapped to the same HARQ-ACK channel as much as possible, so as to increase the flexibility with which base station sends PDCCH with plurality of CCEs and reduce restrictions on the scheduler.

Beginning HARQ-ACK indexes mapped by CCE in each downlink component carrier can be configured on a semi-static basis independently with high-level signaling configuration. For example, in LTE FDD/TDD system, CCE and HARQ-ACK are mapped with a high-level configuration parameter N_{PUCCH}⁽¹⁾, through configuring different parameter N_{PUCCH}⁽¹⁾ for different downlink component carriers, different beginning HARQ-ARQ indexes in each downlink component carrier can be configured.

Beginning HARQ-ARQ indexes mapped by CCE in each downlink component carrier can also be configured with respect to the beginning HARQ-ARQ indexes in a reference downlink component carrier. Provided that beginning HARQ-ARQ indexes in reference downlink component carrier is N_{PUCCH}⁽¹⁾, then the beginning HARQ-ARQ indexes in other component carriers are obtained with respect to N_{PUCCH}⁽¹⁾, such as N_{PUCCH}⁽¹⁾+f(k). Here, k is information related to downlink component carrier. The present invention is not limited to the form of f(k).

In this way, according to CCE and HARQ-ACK mapping methods in LTE FDD/TDD, for FDD system with bandwidth combination, CCE index n_{CCE} in the Kth component carrier is mapped to HARQ-ACK index n_{PUCCH}⁽¹⁾=n_{CCE}+f(k)+N_{PUCCH}⁽¹⁾ for TDD system with bandwidth combination, provided that in each downlink component carrier, CCEs of M downlink subframes are mapped to HARQ-ACK channel in uplink component carrier, its index set is J. If n_{CCE,j} is CCE index in the jth downlink subframe in set J of the kth component carriers, then choose p in (0, 1, 2, 3) that meets Nₚ≦n_{CCE,j}<Nₚ₊₁ and Nₚ=max{0,└[N_{RB}^{DL}×(N_{sc}^{RB}×p−4)]/36┘}, and HARQ-ACK channel index that this CCE is mapped to is n_{PUCCH,j}⁽¹⁾=(M−j−1)×Nₚ+j×Nₚ₊₁+n_{CCE,j}+f(k)+N_{PUCCH}⁽¹⁾, where N_{PUCCH}⁽¹⁾ is a high-level configuration parameter.

Several forms of f(k) are described as follows. k can be a flag of downlink component carrier in a cell, for example, assuming that the system contains N component carriers, then flags of each downlink component carriers are k=0, 1, . . . N−1 respectively. Assuming that the flag of reference downlink component carrier is k₀, f(k)=k/k₀, f(k)=c·(k−k₀), f(k)=mod(k−k₀,N), f(k)=c·mod(k−k₀,N), where c is a high-level configuration parameter or a predefined value. For example, c may be equal to the maximum number of CCEs in downlink component carriers, when various downlink subframes are mapped to different HARQ-ACK channels; c may be equal to the number of CCEs in downlink component carriers provided by the first n OFDM symbols; c may also be set upon the size of common search space to ensure that ACK/NACK mapped by CCE of common search space in each downlink component carrier does not overlap; for example, common PDCCH can contain only 4 or 8 CCEs, so that c is set to 13. In addition, since LTE supports PDCCH having up to L (L equivalent to 8) CCEs, there are only L effective different beginning HARQ-ACK indexes to reduce the restrictions on the scheduler. When the number of downlink component carriers is greater than L, L different beginning HARQ-ACK indexes may be re-used. For example f(k)=mod(k−k₀,L).

Since a unicast PDSCH MBSFN is not transmitted within the subframe, it does not need to feed back HARQ-ACK in the uplink direction. Thus in CCE and HARQ-ACK mapping methods above, a method is to map only CCEs in downlink component carrier without MBSFN subframe to HARQ-ACK channels. If CCEs in control area of MBSFN subframe can schedule PDSCH on other component carriers, then it does not need to distinguish whether the subframe is MBSFN subframe, and CCEs in all downlink component carriers are mapped to HARQ-ACK channels.

As shown in FIG. 6, in user asymmetrical bandwidth combination, the base station configures user equipment to receive PDSCH only on part of downlink component carriers (DL CCC). Different user equipments may configure different locations and numbers of DL CCC. When defining mapping relationship between CCE in downlink component carrier and HARQ-ACK in uplink component carrier, the relationship between CCE in various downlink component carriers and HARQ-ACK in uplink component carriers can be defined by using the mapping methods described above without depending upon the number of uplink and downlink component carriers in specific user equipment. Alternatively, the CCE and the HARQ-ACK mapping method may be defined in the user equipment in accordance with DL CCC and UL CCC configured. In this way, provided that beginning HARQ-ACK index mapped by CCE in each DL CCC is configured relative to main DL CCC, and provided that beginning HARQ-ACK index for main DL CCC is N_{PUCCH}⁽¹⁾. Then the beginning HARQ-ACK indexes of other DL CCCs are obtained with respect to N_{PUCCH}⁽¹⁾, such as N_{PUCCH}⁽¹⁾+f(k). PUCCH This invention is not limited with the form of f(k). Main DL CCC generally corresponds to k equal to 0, while other DL CCCs are queued from k=1 in turn. Several possible forms are f(k)=k, f(k)=c·k, where c is a high-level configuration parameter or a predefined value.

Assuming that in uplink component carriers, a HARQ-ACK channel starting from index N_{PUCCH}⁽¹⁾ is used for transmitting HARQ of dynamic PDSCH, the maximum number of dynamic HARQ-ACK may be limited to N_{AN}. In accordance with the above method, CCEs in a downlink component carrier are mapped to HARQ-ACK channels from HARQ-ACK index consecutively. When N_{PUCCH}⁽¹⁾+N_{AN}−1 th HARQ-ACK channel is reached, then returning to the N_{PUCCH}⁽¹⁾th HARQ-ACK index to continue to map to HARQ-ACK channel, which is equivalent to a mode N_{AN} operation can be obtained through a high-level signaling semi-static configuration or calculating a number of other configuration information. For example, N_{AN} is calculated according to the maximum number of CCEs in downlink component carrier. Within OFDM symbols in a downlink component carrier used to transmit control signals, excluding reference signals, REs other than time frequency resource elements (RE) occupied by PCFICH and PHICH are used for forming CCE. In order to simplify the calculation, the downlink control signals (PCFICH and PHICH) with less overhead may be ignored, so as to configure downlink component carriers with ND_{RB}^{DL} PRBs by N_{AN}=└[N_{RB}^{DL}×(N_{sc}^{RB}×nₘₐₓ−4)]/36┘, where nₘₐₓ is the greatest number of OFDM symbols in the subframe for transmitting downlink control signals.

In this way, according to the mapping methods of LTE FDD/TDD for CCE and HARQ-ACK, in FDD system with bandwidth combination, CCE index n_{CCE} in the kth downlink component carrier is mapped to HARQ-ACK index n_{PUCCH}⁽¹⁾=mod(n_{CCE}+f(k),N_{AN})+N_{PUCCH}⁽¹⁾, where N_{PUCCH}⁽¹⁾ is a high-level configuration parameter.

In the TDD system with bandwidth combination, provided that in each downlink component carrier, CCEs in M downlink subframes are mapped to HARQ-ACK channels in uplink component carriers, and its index set is J. Provided that n_{CCE,j} is CCE index in the jth downlink subframe in set J of the kth component carrier, then choosing p in (0, 1, 2, 3) that meets Nₚ≦n_{CCE,j}<Nₚ₊₁ and Nₚ=max{0,└[N_{RB}^{DL}×(N_{sc}^{RB}×p−4)]/36┘}, then HARQ-ACK index that this CCE is mapped to is n_{PUCCH,j}⁽¹⁾=mod((M−j−1)×Nₚ+j×Nₚ₊₁+n_{CCE,j}+N_{AN})+N_{PUCCH}⁽¹⁾, where N_{PUCCH}⁽¹⁾ is a high-level configuration parameter.

In TDD system with bandwidth combination, mode operation can be made for CCE and HARQ-ACK mapping described above in blocks. HARQ-ACK mapped by each downlink component carrier is divided into a plurality of blocks, each of which is N_{AN,p}=Nₚ₊₁−Nₚ in size, where Nₚ=max{0,└[N_{RB}^{DL}×(N_{sc}^{RB}×p−4)]/36┘}, p=0, 1, 2, 3. Provided that in each downlink component carrier, CCEs in M downlink subframes are mapped to HARQ-ACK channels in uplink component carriers, and its index set is J; and provided that n_{CCE,j} is CCE index in the j th downlink subframe in set J of the kth component carrier, then first choose p in (0, 1, 2, 3) that meets Nₚ≦n_{CCE,j}<Nₚ₋₁, then HARQ-ACK index that this CCE is mapped to is n_{PUCCH,j}⁽¹⁾=(M−j)×Nₚ+j×Nₚ₋₁+mod(n_{CCE,j}−Nₚ+f(k), N_{AN,p})+N_{PUCCH}⁽¹⁾, where N_{PUCCH}⁽¹⁾ is a high-level configuration parameter.

### EMBODIMENT

Six embodiments according to this invention are described. In order to avoid making the description tedious, detailed description of solution well-known is omitted.

### First Embodiment

For the configuration with asymmetrical uplink and downlink bandwidth combination shown in FIG. 6, regardless this symmetry is at cell-level or user-level, schematic diagram of present invention for CCE and HARQ-ACK mapping methods is described as follows.

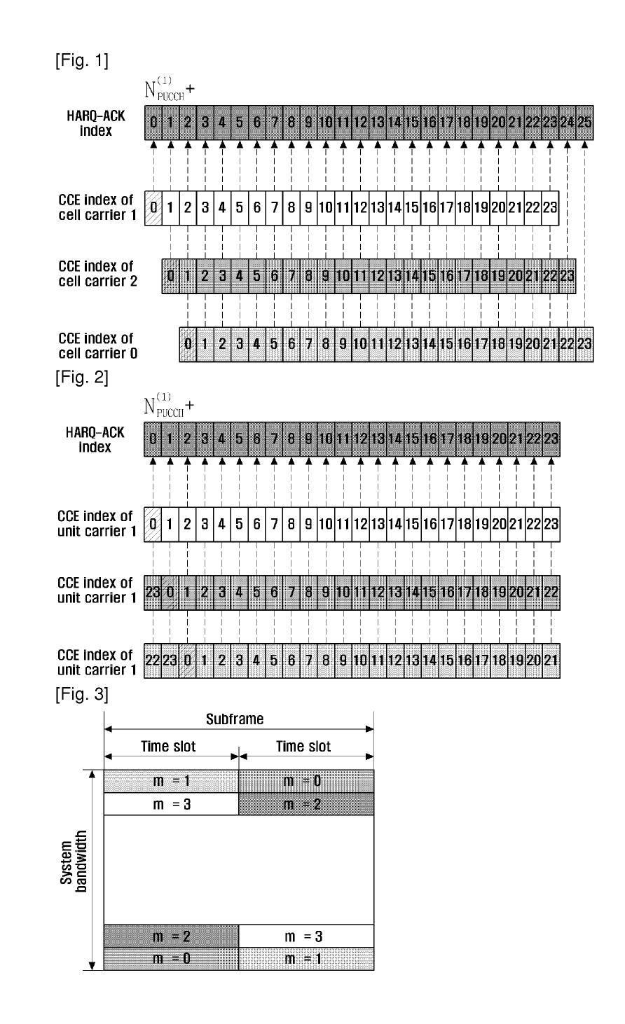

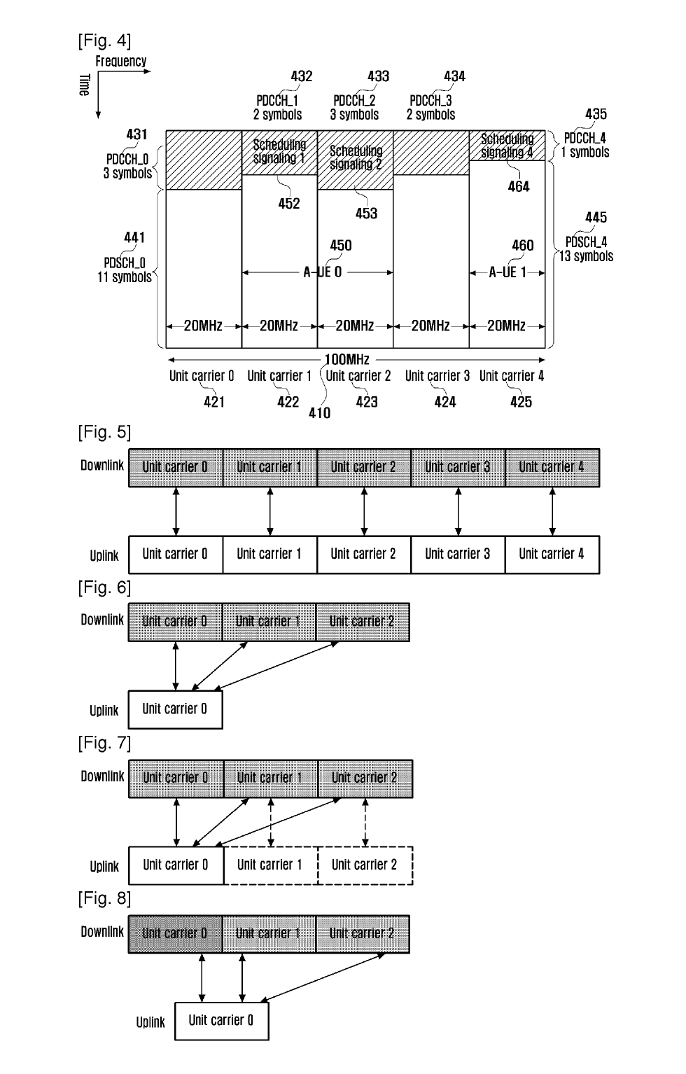

FIG. 1 is a schematic diagram for mapping. It is assumed that a cell contains N=3 downlink component carriers, and their indexes are k=0, 1, 2 while beginning HARQ-ACK index of reference downlink component carrier k₀=1 is N_{PUCCH}⁽¹⁾, this parameter is sent in broadcast channel of downlink component carrier k₀=1. Provided that f(k)=mod(k−k₀, N)=mod(k−1,3), then the beginning HARQ-ACK index of component carrier 2 is N_{PUCCH}⁽¹⁾+1 the beginning HARQ-ACK index of component carrier 0 is N_{PUCCH}⁽¹⁾+2. In LTE system, PDCCH is only composed of 1, 2, 4, or 8 CCEs, thus the mapping method in FIG. 1 is implemented to increase the flexibility for scheduling PDCCH with the plurality of CCEs and reduce the restrictions on the scheduler. PDCCH with 4 CCEs is taken as an example, in each downlink component carrier, such PDCCH may contain 4 CCEs starting from CCE index 0, but actually, the used HARQ-ACK is determined by CCE index 0. By using the mapping method in FIG. 1, CCE index 0 of 3 downlink component carriers is mapped to HARQ-ACK index 0, 1 and 2, and the scheduler can freely schedule PDCCH in each downlink component carrier unit starting from CCE index 0.

### Second Embodiment

For the configuration with asymmetrical uplink and downlink bandwidth combination shown in FIG. 6, the maximum number of dynamic HARQ-ACK allocated in uplink component carriers is limited to N_{AN}.

FIG. 2 is a mapping schematic diagram, it is assumed that a cell includes N=3 component carriers, and its index is k=0, 1, 2, N_{AN} is equal to the maximum number of CCEs in downlink component carrier, N_{AN}=24 as shown in FIG. 2. Beginning HARQ-ACK index of reference downlink component carrier k₀=1 is N_{PUCCH}⁽¹⁾, which is sent in the broadcasting channel of downlink component carrier k₀=1. Provided that f(k)=mod(k−k₀, N)=mod(k−1,3), then the beginning HARQ-ACK index of component carrier 2 is N_{PUCCH}⁽¹⁾+1 the beginning HARQ-ACK index of component carrier 0 is N_{PUCCH}⁽¹⁾+2. It should be noted that CCE mapping to HARQ-ACK limits the maximum number of dynamic HARQ-ACK, N_{AN}=24, or a mold operation N_{AN}=24 is applied, for downlink component carrier 2, CCE index 23 is mapped to HARQ-ACK index N_{PUCCH}⁽¹⁾. For downlink component carrier 0, CCE indexes 22 and 23 are mapped to HARQ-ACK indexes N_{PUCCH}⁽¹⁾ and N_{PUCCH}⁽¹⁾+1. In the same way shown in FIG. 1, the mapping method in FIG. 2 is implemented to increase the flexibility for scheduling PDCCH with several CCEs and reduce restrictions on the scheduler. Meanwhile, as compared with FIG. 1, the uplink HARQ-ACK channel overhead may be reduced.

### Third Embodiment

As shown in FIG. 5, for a typical configuration with symmetrical bandwidth combination, each downlink component carrier is associated with an uplink component carrier, and HARQ-ACK channel allocated in each uplink component carrier is used to transmit HARQ of PDSCH in its associated downlink component carriers, for HARQ transmission of the PDSCH in the L-UE. It is assumed that each downlink component carrier transmits system broadcasting messages, including configuration parameters for CCE and HARQ-ACK mapping on its associated uplink component carriers, such as N_{PUCCH}⁽¹⁾.

Considering the case with user asymmetrical bandwidth combination below, base station can configure user equipment to receive PDSCH only on part of downlink component carriers (DL CCC) and send uplink signals only on part of uplink component carriers (UL CCC). As shown in FIG. 7, some A-UEs simultaneously receive PDSCH on three downlink component carriers, but send uplink signals only on an uplink component carrier. Namely, in a system with symmetrical bandwidth combination in a cell, it is still required to define mapping relationship between CCE in various downlink component carriers and HARQ-ACK in an uplink component carrier, to support subsequent asymmetrical bandwidth combination.

One method is to reuse configuration parameters with the same CCE and HARQ-ACK in each uplink component carrier for a downlink component carrier. For example, it is assumed that a downlink component carrier broadcasts the parameter N_{PUCCH}⁽¹⁾, then when the CCE of this downlink carrier is mapped to any uplink component carrier, the same parameter N_{PUCCH}⁽¹⁾ is used to determine HARQ-ACK channel. Specifically, each uplink component carrier adopts the same formulas and parameters of CCE and HARQ-ACK mapping. For example, for FDD system, HARQ-ACK index that its CCE is mapped to is n_{PUCCH}⁽¹⁾=n_{CCE}+N_{PUCCH}⁽¹⁾. For TDD systems, HARQ-ACK index that is CCE is mapped to is n_{PUCCH,i}⁽¹⁾=(M−i−1)×Nₚ+i×Nₚ₋₁+n_{CCE,i}+N_{PUCCH}⁽¹⁾.

Another method is to configure the beginning HARQ-ACK index that CCE in reference downlink component carrier is mapped to, and then beginning HARQ-ACK indexes mapped by CCEs in other downlink component carriers are configured with respect to the reference downlink component carrier. FIG. 1 and FIG. 2 are schematic diagrams of this method.

### Fourth Embodiment

In the system with bandwidth combination, some component carriers may not support existing L-UE, but be used for A-UE exclusively. FIG. 8 is a schematic diagram, where a cell downlink bandwidth consists of three component carriers, and the uplink bandwidth has only one component carrier, where downlink component carrier 0 supports L-UE, and downlink component carriers 1 and 2 only support A-UE. As downlink component carriers 1 and 2 do not need to support L-UE, they generally do not send SCH and BCH, that is such two downlink component carriers do not send the broadcasting system information, so as not to send configuration parameters related to CCE and HARQ-ACK mapping. For such downlink component carriers no broadcasting the configuration parameters related to CCE and HARQ-ACK mapping, their beginning HARQ-ACK indexes can be set based on a downlink component carrier that broadcasts configuration parameters related to CCE and HARQ-ACK mapping. For example, as shown in FIG. 8, the beginning HARQ-ACK index in downlink component carriers 1 and 2 is set for the downlink component carrier 0. When the system contains a plurality of downlink component carrier that broadcast configuration parameters of CCE and HARQ-ACK mapping, the downlink component carrier serving as the HARQ-ACK mapping reference shall be identified.

Downlink component carrier 0 transmits the broadcasting information, including the parameter N_{PUCCH}⁽¹⁾, so that the HARQ-ACK index mapped by CCE in downlink component carrier 0 in uplink component carrier 0, is n_{PUCCH}⁽¹⁾=n_{CCE}+N_{PUCCH}⁽¹⁾. For the downlink component carriers 1 and 2, the beginning HARQ-ACK indexes for mapping can be configured for downlink component carrier 0, ie. N_{PUCCH}⁽¹⁾+f(k), k=1, 2. For example, it is assumed that f(k)=c·k, c is equal to the maximum number of CCEs in downlink component carrier 0, then CCEs in two downlink component carriers are mapped to different HARQ-ACK channels, to provide maximum flexibility in scheduling.

Beginning HARQ-ACK index N_{PUCCH}⁽¹⁾ is mapped by CCE of downlink component carrier 0 in uplink component carrier 0, or the beginning HARQ-ACK indexes may be determined based on the total number of CCEs in downlink component carriers 0, 1 and 2. For example, beginning HARQ-ACK index mapped by CCE in other downlink component carrier is

$${N}_{PUCCH}^{( 1 )} + {\sum }_{i = 0}^{k - 1} {N}_{CCE , i} ,$$

where N_{CCE,i} is the maximum number of CCEs in downlink component carrier i. In this way, beginning HARQ-ACK index mapped by CCE in downlink component carrier 1 is N_{PUCCH}⁽¹⁾+N_{CCE,0}. The beginning HARQ-ACK index mapped by CCE in downlink component carrier 2 is N_{PUCCH}⁽¹⁾+N_{CCE,0}+N_{CCE,1} to ensure that CCEs in all downlink component carriers are mapped to different HARQ-ACKs, to provide maximum flexibility in scheduling.

### Fifth Embodiment

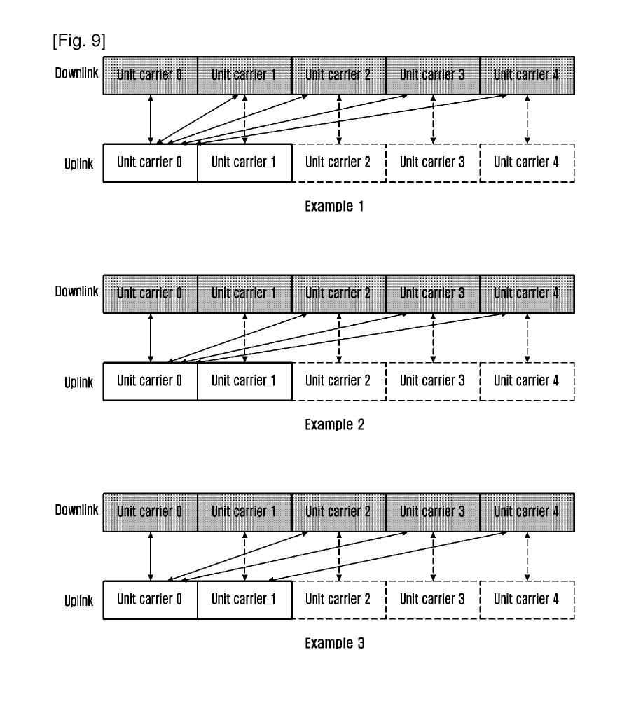

In the communication system with bandwidth combination, it is assumed that the number of uplink is the same as that of downlink component carriers, and each downlink component carrier is associated with one uplink component carrier, while HARQ-ACK channels are allocated within each uplink component carrier for transmitting HARQ of PDSCH in its associated downlink component carrier. In case of user asymmetrical bandwidth combination, the base station may configure a plurality of UL CCCs. As shown in FIG. 9, the base station can configure user equipment to receive PDSCH on five downlink component carriers (DL CCC) send uplink signals on two uplink component carriers (UL CCC). At this time, this user equipment needs to allocate HARQ-ACK channel in each downlink component carrier to two uplink component carriers. On an uplink component carrier, when determining HARQ-ACK mapped by CCE in a downlink component carrier, the method of the present invention can be used for mapping to different beginning HARQ-ACK indexes. The problem to be addressed is to determine which HARQ-ACK in uplink component carrier that CCE in each downlink component carrier is mapped to. Without affecting the generality, further assuming that for this user equipment, downlink component carrier 0 is main DL CCC, which links to uplink component carrier 0; other downlink component carrier is secondary DL CCC, where downlink component carrier 1 relates to uplink component carrier 1.

In an example 1 in FIG. 9, although user equipment configures two component carriers in an uplink direction, only HARQ-ACK in uplink component carrier 0 mapped by main DL CCC is used for sending HARQ-ACK. That is, CCE in each downlink component carrier is mapped to HARQ-ACK in uplink component carrier 0.

In an example 2 in FIG. 9, HARQ-ACKs in two uplink component carriers are used for HARQ transmission of the PDSCH. Each uplink component carrier transmits HARQ-ACK of PDSCH carrier in its associated downlink component carriers. That is, CCE of downlink component carrier 0 is mapped to HARQ-ACK of uplink component carrier 0, while CCE of downlink component carrier 1 is mapped to HARQ-ACK of uplink component carrier 1. DL CCC in the other unassociated uplink component carriers is mapped to UL CCC (uplink component carrier 0) associated with main DL CCC (downlink component carrier 0).

In an example 3 in FIG. 9, HARQ-ACK in each downlink DL CCC is allocated equally to two UL CCCs. Each UL CCC transmits its related HARQ-ACK of PDSCH of DL CCC. That is, CCE in downlink component carrier 0 is mapped to HARQ-ACK in uplink component carrier 0, while CCE in downlink component carrier 1 is mapped to HARQ-ACK in uplink component carrier 1. The other DL CCCs unassociated with UL CCC are divided into two groups and mapped to two UL CCCs respectively. For example, in FIG. 9, DL CCCs 2 and 3 are mapped to UL CCC 0, DL CCC 4 is mapped to UL CCC 1.

### Sixth Embodiment

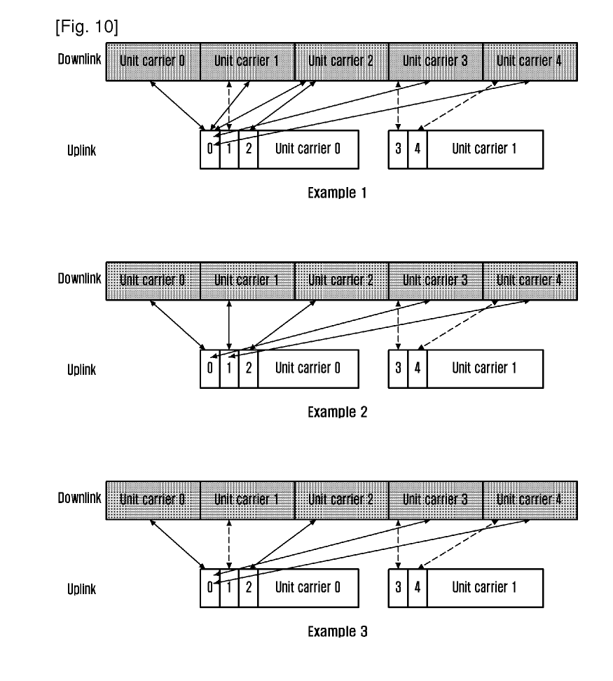

In a cell with bandwidth combination, assuming that downlink component carriers are more than uplink component carriers, as shown in FIG. 10, where a cell includes five downlink component carriers and two uplink component carriers. At this time, uplink HARQ-ACK channels are allocated for each downlink component carrier in its associated uplink component carriers, as downlink component carriers 0, 1 and 2 are associated to uplink component carrier 0. That is, the HARQ-ACK channel is allocated in uplink component carrier 0, so that uplink component carrier 0 is divided into three HARQ-ACK areas, HARQ-ACK-0, HARQ-ACK-1 and HARQ-ACK-2. Downlink component carriers 3 and 4 are associated to uplink component carrier 1, ie., HARQ-ACK channel is allocated in uplink component carrier 1, so that uplink component carrier is divided into two HARQ-ACK areas, HARQ-ACK-3 and HARQ-ACK-4. It should be noted that, in an uplink component carrier, the plurality of HARQ-ACK area can occupy different time frequency resources, or the same uplink time frequency resources in part or in whole.

In case of user asymmetrical bandwidth combination, the base station can configure user equipment to receive PDSCH on five downlink component carriers (DL CCC) and send uplink signals only on one uplink component carrier (UL CCC). At this time, this user equipment needs to define a mapping relationship between CCE in various downlink component carriers and HARQ-ACK in an uplink component carrier. Uplink component carrier shown in FIG. 10 contains a plurality of HARQ-ACK areas, in each of which, when determining HARQ-ACK mapped by CCE in a downlink component carrier, the method of this invention can be used for mapping to the different beginning HARQ-ACK indexes. The problem to be addressed is to determine the HARQ-ACK area in uplink component carrier to which the CCE in each downlink component carrier is mapped. Here, assuming that for this user equipment, downlink component carrier 0 is main DL CCC, and associated to HARQ-ACK-0 of uplink component carrier 0; other downlink component carrier is to secondary DL CCC.

In an example 1 in FIG. 10, although user equipment has three HARQ-ACK areas in uplink component carrier 0, HARQ-ACK is transmitted by using only HARQ-ACK-0 associated with main DL CCC. That is, CCE in each downlink component carrier is mapped to HARQ-ACK-0 in uplink component carrier 0.??

In an example 2 in FIG. 10, 3 HARQ-ACK areas in uplink component carrier 0 are used for HARQ transmission of the PDSCH. Each HARQ-ACK area transmits HARQ-ACK of the PDSCH in its associated downlink component carriers. The other DL CCCs in unassociated uplink component carriers and HARQ-ACK areas are mapped to HARQ-ACK-0 associated with main DL CCC.

In an example 3 in FIG. 10, HARQ-ACK in each downlink DL CCC is allocated equally to three HARQ-ACK areas in uplink component carrier 0. Each HARQ-ACK area transmits HARQ-ACK of the PDSCH in its associated DL CCCs; other DL CCCs without associated uplink component carriers and HARQ-ACK areas are mapped to HARQ-ACK areas in uplink component carrier 0. For example, in FIG. 10, downlink component carrier 3 is mapped to HARQ-ACK-0 in uplink component carrier 0, and downlink component carrier 4 is mapped to HARQ-ACK-1 in uplink component carrier 0.

1. A method for transmitting HARQ-ACK, for N downlink component carriers and 1 uplink component carrier, transmitting HARQ-ACK in-formation of N downlink component carriers in HARQ-ACK channel of an uplink component carrier, one of N downlink component carrier being a reference downlink component carrier, comprising steps of:
on consecutive HARQ-ACK channels beginning with N_{PUCCH}⁽¹⁾, transmitting HARQ-ACK for CCE in the reference downlink component carrier; and
on consecutive HARQ-ACK channels beginning with N_{PUCCH}⁽¹⁾+f(k), transmitting HARQ-ACK for CCE in other downlink component carriers, wherein k is information related to downlink component carrier.

2. The method according to claim 1, wherein, in a FDD system with bandwidth combination, HARQ-ACK index to which CCE index n_{CCE} in the kth component carrier is mapped is n_{PUCCH}⁽¹⁾=n_{CCE}+f(k)+N_{PUCCH}⁽¹⁾, where k is an index of downlink component carrier.

3. The method according to claim 1, wherein, in a TDD system with bandwidth combination, when for each downlink component carrier, CCEs in M downlink subframes are mapped to HARQ-ACK channels in uplink component carriers, and its index set is J, n_{CCE,j} is a CCE index in the j th downlink subframe in set J of the kth component carrier, choosing p in (0, 1, 2, 3) that meets Nₚ≦n_{CCE,j}<Nₚ₋₁ and Nₚ=max{0,└[N_{RB}^{DL}×(N_{sc}^{RB}×p−4)]/36┘}, then HARQ-ACK channel index to which the CCE is mapped is n_{PUCCH,j}⁽¹⁾=(M−j−1)×Nₚ+j×Nₚ₋₁+n_{CCE,j}+f(k)+N_{PUCCH}⁽¹⁾.

4. The method according to claim 1, wherein, f(k)=k−k₀, f(k)=c·(k−k₀), f(k)=mod(k−k₀,N) or f(k)=c·mod(k−k₀,N), where k is a flag of downlink component carrier in a cell, the flag of reference downlink component carrier is k₀, and c is a high-level configuration parameter or a predefined value.

5. The method according to claim 1, wherein only CCE in downlink component carrier without MBSFN subframe are mapped to HARQ-ACK channel.

6. The method according to claim 1, wherein CCEs in all downlink component carriers are mapped to HARQ-ACK channel.

7. The method according to claim 1, wherein for a user asymmetrical bandwidth combination, the method for mapping the CCE and the HARQ-ACK is defined based on DL CCC received.

8. The method according to claim 1, wherein in an uplink component carrier, the maximum number of HARQ-ACK is N_{AN}.

9. The method according to claim 8, wherein N_{AN} is the maximum number of CCE in the downlink component carrier.

10. The method according to claim 8, wherein in the FDD system with bandwidth combination, HARQ-ACK index to which the CCE index n_{CCE} in the kth component carrier is mapped is n_{PUCCH}⁽¹⁾=mod(n_{CCE}+f(k),N_{AN})+N_{PUCCH}⁽¹⁾.

11. The method according to claim 8, wherein in the TDD system with bandwidth combination, when for downlink component carrier, CCEs in M downlink subframes are mapped to HARQ-ACK channels in uplink component carriers, and its index set is J, n_{CCE,j} is CCE index in the j th downlink subframe in set J of the kth component carrier, choosing p in (0, 1, 2, 3) that meets Nₚ≦n_{CCE,j}<Nₚ₊₁ and Nₚ=max{0,└[N_{RB}^{DL}×(N_{sc}^{RB}×p−4)]/36┘}, the HARQ-ACK channel index to which the CCE is mapped is n_{PUCCH,j}⁽¹⁾=mod((M−j−1)×Nₚ+j×Nₚ₊₁+n_{CCE,j}+f(k), N_{AN})+N_{PUCCH}⁽¹⁾, where N_{PUCCH}⁽¹⁾ is a high-level configuration parameter.

12. The method according to claim 8, wherein in TDD system with bandwidth combination, mod operation is made in blocks from CCE to HARQ-ACK, HARQ-ACK mapped by each downlink component carrier is divided into several blocks, each of which is N_{AN,p}=Nₚ₊₁−Nₚ, Nₚ=max{0,└[N_{RB}^{DL}×(N_{sc}^{RB}×p−4)]/36┘} in size, p=0, 1, 2, 3 when for each downlink component carrier, CCEs in M downlink subframes are mapped to HARQ-ACK channels in uplink component carriers, its index set is J and n_{CCE, j} is CCE index in the j th downlink subframe in set J of the kth component carrier, choosing p in (0, 1, 2, 3) that meets Nₚ≦n_{CCE,j}<Nₚ₋₁, then HARQ-ACK channel index that this CCE is mapped to is n_{PUCCH}⁽¹⁾=(M−j)×Nₚ+j×Nₚ₋₁+mod(n_{CCE,j}−Nₚ+f(k),N_{AN,p})+N_{PUCCH}⁽¹⁾, where N_{PUCCH}⁽¹⁾ is a high-level configuration parameter.
